(19) United States
(12) Patent Application Publication
(10) Pub. No.: US 2004/0152358 A1
(43) Pub. Date: Aug. 5, 2004

(54) Electrical architecture for a vehicle door

(76) Inventors: Emmanuel Huber, Olivet (FR); Frederic Burkat, Bouzy la Foret (FR); Jean-Marc Belmond, St Jean Le Blanc (FR)

Correspondence Address: CARLSON, GASKEY & OLDS, P.C., 400 WEST MAPLE ROAD, SUITE 350, BIRMINGHAM, MI, 48009, US

(21) Appl. No.: 10/684,966

(22) Filed: Oct. 14, 2003

(30) Foreign Application Priority Data
Oct. 15, 2002 (FR) 02 12 800

(51) Int. Cl. H01R 11/00

(52) U.S. Cl. 439/505

(57) ABSTRACT

An electrical architecture for vehicle doors includes a lock subassembly, a control module and a door controller, where the lock subassembly and the control module are connected to the door controller by a single harness. The architecture reduces the mass and bulk of the electrical wires inside the door.

### REFERENCE TO RELATED APPLICATIONS

This invention claims the benefit of French Patent Application No. 02 12 800, filed Oct. 15, 2002.

### TECHNICAL FIELD

This invention relates to an electrical architecture for vehicle doors, a vehicle door comprising an electrical architecture and an assembly method for vehicle door peripherals.

### BACKGROUND OF THE INVENTION

Automobile vehicles are being developed with an increasing number of electrically powered peripherals. For example, the peripherals on doors may include electric windows, electrically adjustable rear view mirrors, etc. These peripherals can be activated by a door controller. The door controller is electrically connected to the rest of the vehicle by a bus. The peripherals are connected to the controller by connections.

The drawback of this type of architecture is that the number of connections and the type of peripherals are determined in advance based on the equipment level of the door. The architecture is then given a reference for each vehicle door peripheral equipment level. As a result, there are as many types of electrical architecture as there are different vehicle door equipment levels. This leads to the production and storage of different electrical architectures.

There is a desire for an electrical architecture for use in vehicle doors that has lower mass and bulk than currently known architectures.

### SUMMARY OF THE INVENTION

The invention provides an electrical architecture for vehicle doors comprising a lock subassembly, a control module and a door controller. The subassembly and the module are connected to the door controller by a single harness.

In various embodiments, the lock subassembly and the control module can be made integral, separable, and/or connected by a breakable connection.

The invention also relates to a vehicle door comprising the architecture described above.

The invention also relates to an assembly method for peripherals that comprise an electrical circuit, the method comprising the steps of positioning of the electrical circuits for the peripherals in a mold, positioning one end of a cable harness in the mold in contact with the electrical circuits, and simultaneously molding the peripherals. In one embodiment, the method also comprises a peripheral separation step. The peripherals may be a lock subassembly and a control module.

### BRIEF DESCRIPTION OF THE DRAWINGS

Further characteristics and advantages of the invention are given in the following detailed description of the embodiments of the invention, given by way of example only and with reference to the drawings, of which:

FIG. 1 is a representative diagram of an electrical architecture according to one embodiment of the invention;

FIG. 2 is representative diagram of an example of a door architecture according to one embodiment of the invention.

### DETAILED DESCRIPTION OF PREFERRED EMBODIMENTS

Generally, the invention is directed to an electrical architecture for vehicle doors comprising a door controller to which a lock subassembly and a control module are connected by a single harness. The advantage of this architecture is that several peripherals are powered by a single cable harness, allowing reduction of the mass and bulk of the electrical wires inside the door.

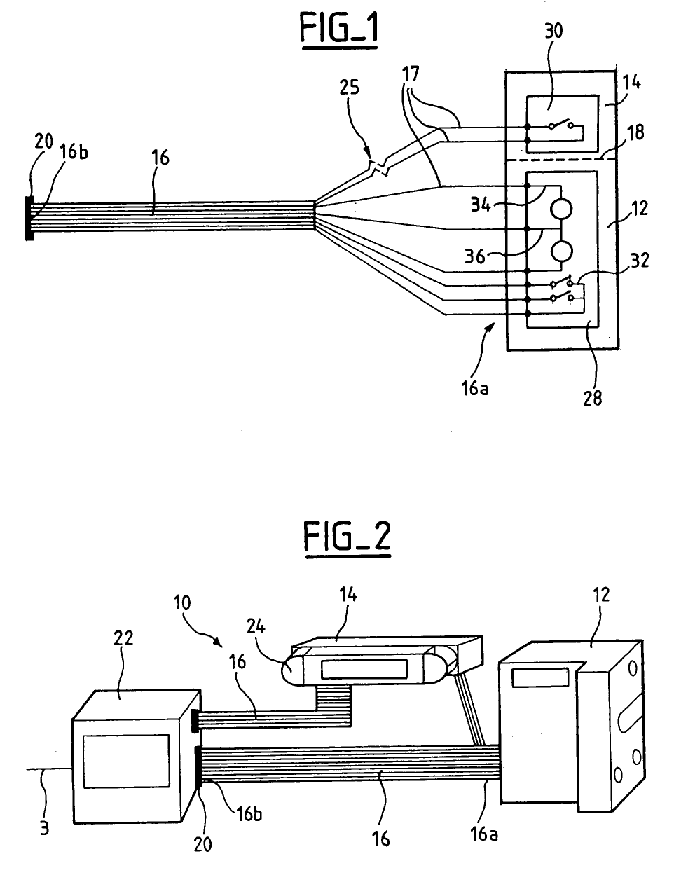

FIGS. 1 and 2 are representative diagrams of an electrical architecture 10 according to one embodiment of the invention. As shown in FIG. 2, the architecture 10 comprises a door controller 22 and peripherals, such as a lock subassembly 12 and a control module 14. The lock subassembly 12 and the control module 14 are connected by a single harness 16 to the door controller 22. The door controller 22 activates these peripherals 12, 14.

The harness 16 is, for example, a flat flexible cable structure composed of multiple electrical wires 17, which can carry low levels of electrical current to be sent to electrically activated peripheral devices. The harness 16 is preferably flexible in the sense that it can be bent at will to connect different peripheral devices inside the door. In particular, the harness 16 also allows peripheral devices in different zones of the door to be connected together; for example, the harness 16 may connect a peripheral device disposed in a dry zone (on the side of the door facing the interior of the vehicle) to a peripheral device disposed in a wet zone (on the side of the door facing the outside of the vehicle).

The lock subassembly 12 may comprise a movable hook (not shown) that engages with a ring fixed to the door frame. According to the embodiment in FIG. 1, the lock subassembly 12 comprises an electrical circuit 28 having one or more branches 32 that operate different electrically activated units. For example, one branch 32 of the electrical circuit 28 may allow for a ceiling light in the vehicle to be switched on to indicate that the door is open. As a further example, another branch 34 of the electrical circuit triggers emergency opening of the vehicle door in the event of an accident. To do this, yet another branch 36 of the electrical circuit allows the movable hook to be activated by a motor to open the door.

The control module 14 can provide the door controller 22 with user information to open the vehicle door via an associated electrical circuit 30.

The harness 16 comprises electrical wires 17 that form a flat flexible cable structure and that can be separated into individual wires 17 at one end 16a of the harness 16. This allows the wires to be connected separately to the lock subassembly 12 and the control module 14. According to the embodiment shown in FIG. 1, the wiring harness 16 may comprise eight wires, with two of the wires supplying current to the control module 14 and the other six wires supplying current to the lock subassembly 12.

According to one embodiment, the lock subassembly 12 and the control module 14 are integrally connected together by, for example, being molded simultaneously in a single molding step. This reduces the production time needed to manufacture these peripherals. The integral construction of the lock subassembly 12 and the control module 14 is facilitated by the use of a single wiring harness 16 supplying current to the subassembly 12 and the module 14.

The lock subassembly 12 and the control module 14 may be separable, allowing them to be placed in different locations in the door. Advantageously, according to the embodiment shown in FIG. 1, the wires 17 may project individually from one end 16a of the wiring harness 16. Thus, once the control module 14 and the lock subassembly 12 have been separated, the two peripherals can be placed in different locations in the door depending on the space available.

To allow for the separation, the lock subassembly 12 and the control module 14 may be connected by a breakable connection 18, as shown in FIG. 1. The term “breakable connection” is used to describe a connection that can be broken by hand by a user without excessive effort and that does not alter the structure of the peripherals being separated. For example, the connection 18 may be a line of perforated material. By bending the control module 14 back and forth several times relative to the lock subassembly 12, the user weakens and breaks the connection 18. The connection 18 may also, for example, be a connecting tab between the subassembly 12 and the module 14 that breaks when the peripherals 12 and 14 are twisted relative to each other. The connection 18 is advantageously formed during the simultaneous molding of the subassembly 12 and the module 14. The advantage of such a connection is that the two peripherals can be produced simultaneously while still allowing them to be placed in different locations in the door.

In one embodiment, the end 16a of the wiring harness 16 supporting the lock subassembly 12 and the control module 14 is molded into the lock subassembly 12 and the control module. The connection between the end 16a of the wiring harness and the subassembly 12 and the module 14 is a direct connection. The end 16a of the wiring harness is immobilized in the subassembly 12 and the module 14 so that it carries current to the electrical circuits of the subassembly 12 and the module 14. The end 16a is incorporated into or integral with the lock subassembly 12 and the control module 14.

In one embodiment, the connection between the wiring harness and the lock subassembly 12 and the control module 14 is connectorless. This connectorless structure eliminates a costly connector (e.g., a connector socket for the wiring harness 16 on the subassembly 12 or the module 14) between the end 16a and the subassembly 12 and the module 14. This further reduces the cost of manufacturing the architecture 10. A further advantage is that connection errors can be prevented in a connectorless structure. The molding of the end 16a in the subassembly 12 and the module 14 allows in particular for a watertight connection. Thus, eliminating the connector allows the subassembly 12 and/or the module 14 to be placed in a wet zone of the door (i.e., the part of the door facing the outside of the door) without risking water leakage into the architecture 10.

Another advantage is that the assembly of the architecture 10 is faster as production by molding means that the architecture can be obtained in a single molding step. The architecture also allows for a reduction in the number of spare parts. The connection between the wiring harness 16 and the lock subassembly 12 and the control module 14 is non-detachable, and detachment causes the destruction of one or other of the components. This has the advantage of preventing any accidental detachment of the connection.

According to the example shown in FIG. 1, the electrical wires 17 are gathered in a flat flexible cable structure along a section of the length of the wiring harness 16 and then separated at the end 16a of the wiring harness 16. This allows for them to be connected at different points of the electrical circuits of the subassembly 12 and the module 14. The length of the separated section of the wires 17 may vary so that the lock subassembly 12 and the control module 14 can be offset in different locations in the door. Thus, in FIG. 1, the wires 17 connected to the module 14 are schematically shown by a gathered section marked 25 as being longer than the wires 17 connected to the subassembly 12. The free ends of the wires 17 may be embedded in the body of the subassembly 12 and the module 14.

The wires 17 that form the gathered section 25 may be advantageously separated so that the subassembly 12 and the module 14 can be located even further apart.

In the embodiment shown in FIG. 1, the wiring harness 16 also has a connector 20 at its other end 16b. The connector 20 allows the wiring harness to be connected to a unit, such as a door controller, as will be explained in more detail below in connection with FIG. 2. In this embodiment, the connector 20 may be a dry zone connector or a wet zone connector. Moreover, both ends 16a, 16b of the wiring harness 16 may have separated wires 17. The second end 16b of the wiring harness 16 may be molded into the door controller 22 to eliminate the need for separate connection structures, reducing the cost of the architecture 10.

Note that although the above architecture 10 incorporates a connectorless method to link the door controller 22, control module 24, and lock subassembly 26 together, connectors may also be used without departing from the scope of the invention. Connectors may increase the cost of the architecture 10, but they also provide flexibility after the peripherals have been manufactured, allowing a designer to choose and connect a peripheral to the controller easily when the door is assembled without having to determine the peripheral in advance before the electrical architecture 10 is manufactured, as is the case for connectorless architectures.

Another embodiment of the invention is directed to an assembly method for vehicle door peripherals. For example, the peripherals assembled in the examples described above are the lock subassembly 12 and the control module 14.

In one embodiment, the electrical circuits 28, 30 of the lock subassembly 12 and the control module 14 are first positioned in a mold. Next, one end 16a of the wiring harness is positioned in the mold in contact with the electrical circuits 28, 30 of the subassembly 12 and the module 14. The lock subassembly 12 and the control module 14 are then simultaneously molded. Thus, in one molding step, the lock subassembly 12 and the control module 14 can be joined to each other and to the wiring harness 16. Preferably, the wires 17 of the wiring harness 16 are separated before the first end 16a of the harness 16 is placed in the mold. Advantageously, the wires 17 are soldered to the electrical circuits of the subassembly 12 and the module 14. This ensures that the end 16a of the wiring harness 16 is securely connected to the electrical circuits.

The mold advantageously has a configuration allowing for the breakable connection 18 between the lock subassembly 12 and the control module 14 to be formed. For example, the mold has compartments for each of the peripherals 12, 14, separated by walls over which a layer of material links the two units. The mold may also have a connecting tab between the two compartments.

The manufacturing method may also comprise a step in which the peripherals 12 and 14 are separated from each other. This step may be achieved by, for example, bending or twisting the peripherals 12 and 14 with respect to each other as explained above. This step allows for the peripherals 12, 14 to be separated from each other while maintaining their respective connections to the wiring harness 16.

FIG. 2 is an example of a door architecture 10 according to one embodiment of the invention. In the illustrated embodiment, the door architecture 10 comprises three peripherals 12, 14, 24. Note that it is possible to connect a greater number of peripherals than in the illustrated example without departing from the scope of the invention. This allows the electrical architecture to be adjusted to the door peripheral equipment level. In the example shown in FIG. 2, the peripherals 12 and 14 are joined together and connected to the door controller 22 by a single wiring harness 16. The peripherals 12 and 14 are, for example, the lock subassembly 12 and the control module 14. The peripheral 24 is, for example, a door handle electrically connected to the door controller by another wiring harness 16.

In the example of FIG. 2, the wires 17 are not separated. Moreover, the lock subassembly 12 and the control module 14 have been separated. As can be seen in the drawing, having a single wiring harness 16 supplying the subassembly 12 and the module 14 allows for a reduction in the length of the wiring harness used. Moreover, the single wiring harness 16 can then be connected to the door controller 22 by a single connector 20. This makes the device less costly, lighter and less bulky.

The invention also relates to an automobile vehicle door comprising the architecture 10 described above. Depending on the peripheral equipment of the door, the architecture 10 can be adjusted by changing the peripheral or by increasing the number of peripherals connected to the door controller. This means that a specific architecture does not have to be produced for each type of door with a type of peripheral equipment. Another advantage is that the architecture can be fitted indiscriminately to all of the doors on a single vehicle. Yet another advantage is the increased quality of the architecture, as any faulty peripheral can easily be disconnected and replaced.

Of course, this invention is not limited to the embodiments described by way of example. Wiring harnesses have been described for the connections, but buses rather than wiring harnesses could also be used.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. An electrical architecture for a vehicle door, comprising:
a first peripheral device;
a second peripheral device;
a third peripheral device; and
a single wiring harness connecting the first and second peripheral devices to the third peripheral device.

2. The architecture according to claim 1, wherein the first peripheral device is a lock subassembly, the second peripheral device is a control module, and the third peripheral device is a door controller.

3. The architecture according to claim 1, wherein the first and second peripheral devices are integrally connected together to form an integral unit.

4. The architecture according to claim 3, wherein the wiring harness has a first end that is molded into at least one of the first and second peripheral devices.

5. The architecture according to claim 3, wherein the integrally connected first and second peripheral devices are separable.

6. The architecture according to claim 5, wherein the first and second peripheral devices are connected together by a breakable connection.

7. The architecture according to claim 6, wherein the breakable connection is a perforated section.

8. The architecture according to claim 6, wherein the breakable connection is at least one connecting tab.

9. The architecture according to claim 5, wherein the wiring harness has a first end that is molded into at least one of the first and second peripheral devices, and wherein the wiring harness comprises a plurality of wires that are separable from each other when the first and second peripheral devices are separated from each other.

10. The architecture according to claim 1, wherein the wiring harness has a first end that is molded into at least one of the first and second peripheral devices.

11. The architecture according to claim 1, further comprising a connector socket that accommodates the wiring harness and that is disposed on at least one of the first and second peripheral devices.

12. The architecture according to claim 1, wherein the wiring harness comprises a plurality of wires that are separable from each other.

13. A vehicle door comprising an electrical architecture comprising:
a lock subassembly;
a control module;
a door controller; and
a single wiring harness connecting the lock subassembly and the control module are connected to the door controller inside the vehicle door.

14. The vehicle door of claim 13, wherein the lock subassembly and the control module are disposed in different locations in the vehicle door.

15. The vehicle door according to claim 13, wherein the first and second peripheral devices are integrally connected together to form an integral unit.

16. The vehicle door according to claim 15, wherein the integral lock subassembly and control module are connected by a breakable connection.

17. The vehicle door according to claim 13, wherein the wiring harness has a first end that is molded into at least one of the lock subassembly and the control module.

18. The vehicle door according to claim 13, wherein the wiring harness comprises a plurality of wires that are separable from each other.

19. The vehicle door according to claim 13, wherein one of the lock subassembly and the control module is disposed in a wet zone of the vehicle door, and the other of the lock subassembly and the control module is disposed in a dry zone of the vehicle door.

20. A method of manufacturing an electrical architecture for a vehicle door, comprising:
placing a first electrical circuit corresponding to a first peripheral device and a second electrical circuit corresponding to a second peripheral device in a mold;
connecting an end of a wiring harness to the first and second electrical circuits in the mold; and
simultaneously molding the first and second electrical circuits to form the first and second peripheral devices.

21. The method according to claim 20, wherein the first and second peripheral devices are integrally connected together, and wherein the method further comprises separating the first and second peripheral devices from each other.

22. The method according to claim 20, wherein the first peripheral device is a lock assembly and the second peripheral device is a control module.
